(19) United States
(12) Patent Application Publication
(10) Pub. No.: US 2002/0153213 A1
(43) Pub. Date: Oct. 24, 2002

(54) Friction disc, process for the production thereof and vehicle brake

(76) Inventors: Udo Gruber, Neusass (DE); Michael Heine, Allmannshofen (DE); Andreas Kienzle, Thierhaupten (DE)

Correspondence Address: LERNER AND GREENBERG, P.A., POST OFFICE BOX 2480, HOLLYWOOD, FL, 33022-2480, US

(21) Appl. No.: 10/125,085

(22) Filed: Apr. 17, 2002

(30) Foreign Application Priority Data
Apr. 18, 2001 (DE) 101 18 921.4

(51) Int. Cl. F16D 65/10

(52) U.S. Cl. 188/218 XL; 188/218 R

(57) ABSTRACT

A friction disc includes a cylindrical zone A, which is force-lockingly or frictionally connected to a shaft as a supporting disc, and at least one cylindrical annular zone B. The annular zone B has a side remote from the supporting disc in which recesses are formed. The recesses may be radially trapezoidal and/or involutely curved and/or elliptical and/or circular and/or polygonal and open and/or closed towards the periphery and/or the center. The material of the supporting disc A is a fiber-reinforced ceramic material shaped from a single piece in the green state prior to ceramization. The material of the annular zone B is a ceramic material which is optionally fiber-reinforced. The ceramic material of the annular zone B and the material of the matrix of the fiber-reinforced ceramic of the supporting disc A are selected independently of one another from silicon, silicon carbide, silicon nitride, carbon, boron nitride, boron carbide, Si/B/N/C and mixtures thereof. A process for the production thereof and an application in brake systems or clutch systems for vehicles are also provided.

### BACKGROUND OF THE INVENTION

FIELD OF THE INVENTION

The invention relates to a friction disc, such as a vehicle brake, including a cylindrical zone, which is to be force-lockingly or frictionally connected to a shaft as a supporting disc, and at least one cylindrically shaped annular zone constructed as a friction layer and connected with a top surface of the supporting disc. The invention also relates to a process for the production of the friction disc. A force-locking connection is one which connects two elements together by force external to the elements, as opposed to a form-locking connection which is provided by the shapes of the elements themselves.

The principle of cooling brake discs by surface enlargement and the generation of forced circulating air is known from the field of cast iron brake discs. The structural measures generally provided for achieving that aim are recesses or bores perpendicular to the friction surface such as, for example, in U.S. Pat. No. 3,809,192, or internally ventilated discs which are produced. The principle of the internally ventilated brake disc is described inter alia in German Published, Non-Prosecuted Patent Application 25 07 264, in which two parallel-oriented annular brake discs are connected by transverse ribs. In that way, radially oriented channels are formed which extend inside the brake disc. German Published, Non-Prosecuted Patent Application 25 07 264 likewise discloses combining the principle of internal ventilation channels with recesses or passages.

The purpose of those structural measures is to achieve favorable cooling behavior by internal cooling of the brake disc, in such a way that steel or cast iron discs do not undergo excessive heating on braking, which would lead to an impairment of response and of the coefficient of friction. Overheating of the material and damage may nonetheless rapidly occur under maximum load.

A substantial improvement in braking performance is achieved with brake discs of CFC (carbon fiber-reinforced carbon). That material has proved useful, for example, for high-performance in aircraft construction. However, a significant disadvantage in that case is the low oxidation resistance of the carbon, which leads to considerable wear during use with admittance of air. A certain degree of improvement in that problematic behavior may be achieved by sealing the surfaces with protective layers. The internal ventilation principle has also been applied to fiber composites from the carbon group, as are described in German Published, Non-Prosecuted Patent Application DE 198 16 381 A1. However, those brake systems have also proved unsuitable for long-term use in road vehicles.

A substantial improvement in the characteristics relevant to brake applications has resulted from the use of chopped fiber-reinforced composites of C/SiC. “IC/SiC” is understood herein to mean a composite having a matrix which is formed substantially of silicon carbide, silicon and carbon and that is reinforced with carbon fibers. Such materials are described inter alia in German Patent DE 44 38 455 C1, corresponding to U.S. Pat. No. 6,086,814. They are produced by infiltrating liquid silicon into porous carbon fiber-reinforced carbons and subsequent heat treatment, with at least some of the silicon reacting with carbon to form silicon carbide.

German Published, Non-Prosecuted Patent Application DE 197 10 105 A1, corresponding to U.S. Pat. Nos. 6,030,913 and 6,231,791 B1, discloses a production process and the use of C/SiC in brake applications. That class of materials is exceptionally well suited to brake applications due to its high and comparatively temperature-independent coefficients of friction, its good response and exceptionally good wear resistance.

Internally ventilated brake discs have also been made with that material. A possible structural realization thereof is implemented in German Published, Non-Prosecuted Patent Application DE 199 25 003 A1. It is clear therefrom that the ventilation channels inside the brake disc are formed in particular by joining two textured half-shells with channel-like recesses. A disadvantage is that joining and adhesively bonding CFC semi-finished products is a cost-intensive operation and may result in mechanical weakening of the overall composite as a result of the adhesive or joining layer. A particular disadvantage is the very considerable mechanical weakening of the brake disc compared with a solid construction. The weakening results from the cavities. That weakening is also present in the force-bearing region of the brake disc, the supporting zone.

A further problem arises in that C/SiC undergoes oxidative damage at extremely elevated temperatures, such as may occur under extreme brake loading. Such damage is introduced from the surface through burning-up of C fibers. A disadvantage of all internally ventilated constructions is that the damage is introduced preferentially into the force-bearing supporting zone through the ventilation channels due to supply of oxygen.

Another structural solution to the use of C/SiC as frictional material is described in German Published, Non-Prosecuted Patent Application DE 197 21 647 A1. A friction unit described therein is formed of friction members incorporated into a brake disc as a mounting component. The friction members project beyond the surface of the mounting component. Both mounting members and friction members are made of a material containing carbon and/or silicon carbide. Heat is dissipated from the friction surfaces of the individual projecting friction members in such a way that air may flow past the projecting friction member pins and the fiber orientation of the highly anisotropically thermally conductive fibers perpendicular to the long axis of the supporting member improves heat dissipation. A considerable disadvantage in that case is a complex production method, in which the numerous friction members have to be produced separately, introduced into the mounting component and connected. Moreover, uniform, low-wear sliding of the brake lining over the projecting pins is difficult to achieve.

### SUMMARY OF THE INVENTION

It is accordingly an object of the invention to provide a friction disc, such as a vehicle brake, and a process for the production thereof, which overcome the hereinafore-mentioned disadvantages of the heretofore-known products and processes of this general type, in which the friction disc is made from a fiber-reinforced ceramic composite, in particular a C/SiC brake disc, with undiminished load-absorbing capacity, which means, inter alia, that channels and recesses for cooling inside a mechanically loaded supporting zone may be dispensed with, as far as possible, in which the disc is preferably to be made in one piece and in which, in particular, it is intended to dispense with composite-weakening adhesive bonding inside the supporting zone and machining for producing external ventilation.

With the foregoing and other objects in view there is provided, in accordance with the invention, a friction disc, such as a vehicle brake, comprising a cylindrical zone A to be force-lockingly connected to a shaft. The cylindrical zone A is formed as a supporting disc having a top surface. At least one cylindrical annular zone B is formed as a friction layer and connected with the top surface of the supporting disc. The annular zone B has a side remote from the supporting disc with recesses formed therein. The recesses have at least one shape which may be radially trapezoidal and/or involutely curved and/or elliptical and/or circular and/or polygonal. The recesses are open and/or closed towards a periphery and/or a center. The supporting disc A is formed of a fiber-reinforced ceramic material having a matrix material and the supporting disc A is shaped from a single piece in a green state prior to ceramization. The annular zone B is formed of a ceramic material which is optionally fiber-reinforced. The ceramic material of the annular zone B and the matrix material of the fiber-reinforced ceramic of the supporting disc A are selected independently of one another from silicon, silicon carbide, silicon nitride, carbon, boron nitride, boron carbide, Si/B/N/C and mixtures thereof.

The invention provides a cooling system in the form of external cooling channels, passages and/or recesses disposed in the friction layer or in the friction zone in such a manner that braking energy is dissipated from the surface, in part by forced circulating air cooling to the external air and in part by thermal conduction into the supporting disc, with the supporting disc having a solid construction, without internal channels or recesses. A further advantage is that this friction disc may be produced by a cost-effective manufacturing process. The cost-reducing effect thereof is based in particular on the fact that the adhesion and joining of a plurality of (CFC) semi-finished products is dispensed with, since the friction disc formed of the supporting disc and the friction zone is made particularly preferably in one piece and the channel structure is produced during green compact production.

Si/B/N/C are understood herein to mean ceramic mixed phases including at least two phases, with the materials of the individual phases being selected from the elements silicon, boron and carbon together with binary, ternary and quaternary compounds of the above-mentioned elements silicon, boron, nitrogen and carbon.

A further advantageous feature of this structural configuration is that the core material of the supporting disc A may act as a heat reservoir or buffer. In contrast to internal cooling, the core has a solid construction and therefore has a higher thermal capacity.

Another advantage of the invention is the rapid cooling of the surface of the annular zone B, having an external surface in contact with brake linings which acts as a friction surface, and the therefore lower thermal loading of the peripheral components than with internal cooling. If the annular zone B is in direct contact with the brake linings in a brake structure, it is also referred to below as a friction layer or friction zone for the sake of simplicity.

A further substantial advantage of the invention is that the heating zone in the center of the supporting disc is protected from exposure to air due to the omission of internal ventilation channels. In this way, burning up of carbon-containing or C fibers in the event of overheating of the disc caused by overloading may occur only at the surface of the friction zone. Therefore, weakening of the load-bearing supporting disc is avoided to a considerable extent.

Furthermore, the composition of the friction zone according to the invention may exhibit a lower C fiber content than the supporting zone. In this way, greater tolerance with respect to oxidative damage is achieved. This higher tolerance is achieved according to the invention at the same time as good friction characteristics due to a higher SiC content and a reduction in the C fiber volume fraction of the friction zone.

Surprisingly, the braking characteristics and mechanical strength of a brake disc of C/SiC are not impaired in comparison to a brake disc of cast iron or steel by the use-determined temperature increase during braking, but rather is sometimes even markedly improved. This is expressed in particular in the mechanical properties in the supporting zone, namely the strength of the C/SiC material does not decrease as the temperature increases, as it does with cast iron, but instead increases. At 1200° C., bending strength may increase in comparison to that at room temperature by virtually 100%. The flexural modulus of elasticity also increases with increasing temperature, firstly passing through a trough in the lower temperature range. It is therefore favorable to increase the temperature of the mechanically stressed, load-bearing components. The external ventilation according to the invention generates a thermal gradient towards the central supporting disc. This supports the advantageous nature of the external ventilation layout according to the invention.

The friction disc is preferably constructed from a C/SiC composite. Overall, the friction disc may be constructed from various C/SiC material compositions, in such a way that the friction and supporting zones may have different material properties.

The annular zone B is that part of the friction disc which contains the channels, recesses and/or indentations, with the thickness of this ring zone or friction layer over the depth of these above-mentioned recesses being defined as the maximum value of the depth of one of the recesses in the relevant surface. In the event of additional bores or recesses which pass through the entire disc, the depth thereof should naturally not be taken into account in determining the thickness of the friction layer.

The production process for the friction discs according to the invention is divided into a manufacture of a porous, carbon-containing fiber composite, preferably CFC, to a nearly net shape, in particular through the use of a pressing process, and the subsequent infiltration and reaction with liquid silicon. In particular, the carbon in the matrix of the fiber composition is converted at least in part into silicon carbide. That is described, for example, in German Published, Non-Prosecuted Patent Application DE 197 10 105 A1, corresponding to U.S. Pat. Nos. 6,030,913 and 6,231,791 B1.

All high temperature-resistant fibers are feasible reinforcing fiber materials, in particular those made from ceramic raw materials, with carbon-containing fibers, in particular carbon, graphite, SiC and SiBNC fibers being preferred. If the listed carbon-containing fibers are used, the ceramic composite produced by liquid silicification (infiltration of the porous substrate with liquid silicon and subsequent reaction of at least one component of the matrix with silicon) is designated below as C/SiC.

In order to produce the porous carbon-containing fiber composite or CFC body having a nearly net shape, molding compositions of fibers, fiber bundles, pitch and resin are firstly produced and palletized. Fibers or fiber bundles are preferably used which have a protective layer predominantly formed of carbon, that is produced by one-off or repeated coating with resin or pitch and subsequent pyrolysis. However, it is also possible to use fibers which include pyrocarbon layers. Powdery additives, such as powdered coal, graphite, silicon carbide or silicon may also be added to the mixture as further components.

The compositions may vary with regard to fiber lengths, fiber length distribution and quantity of individual components, depending on the purpose the material in the subsequently formed SiC/C/Si matrix has to fulfill.

The fiber content of the mixture is selected in such a way that a volume fraction of fibers of from 0 to 80%, preferably 2 to 60%, and particularly preferably 20 to 40% is present in the ceramized form (the silicated ceramic).

The compositions of the materials (preferably of the C/SiC composites) to be selected for optimum friction characteristics and for optimum load-bearing characteristics (torsional modulus of elasticity and torsional strength) are generally different from one another. The differences relate both to the fiber content and to average fiber length and fiber length distribution of the fibers contained in the composite ceramic material. Different characteristics are also obtained as a function of the fiber bundle thickness or the basic filament number in the fiber bundle.

Chopped fibers and more particularly chopped fiber bundles are preferred as the fiber material. Chopped fibers are understood to mean lengths of from 0.01 to 80 mm, preferably 0.02 to 8 mm. Fiber bundles are understood to mean agglomerates of from 5 to 5000 individual filaments, which are primarily oriented in parallel. The agglomerates are held together by a carbon-containing and/or SiC-containing matrix.

In the optimum composition of the friction zone, the fiber content is typically lower than in the supporting disc, as mentioned above. The volume fraction of fibers in the material of the supporting disc is conventionally at least 1.01 times, preferably at least 1.05 times, and particularly preferably at least 1.5 times the volume fraction in the friction zone.

If the compositions of the friction and supporting zones differ, the composite body preferably also includes a gradient with respect to the length and/or content (volume or mass fraction in the material) of reinforcing fibers. This is provided in such a way that the fiber length and fiber mass fraction increases in the direction of the supporting disc or the center thereof.

This gradient may also be superimposed on a fiber bundle thickness gradient, with the fiber bundle thickness increasing from the annular zone B towards the supporting disc A. The fiber bundle thickness is defined, as conventionally, as the product of the average number of individual filaments in a bundle and the (average) linear density of the individual filaments. The fiber bundle thickness of the supporting disc A is conventionally at least 1%, preferably at least 5%, and particularly preferably at least 10% higher than that of the annular zone B. This gradient structure may exhibit discontinuities, which may be caused, for example, by an adhesive layer.

However, depending on the requirements and construction of the component, it is also possible to select the same fiber content for the supporting and friction zones. Similarly, it is not essential for the length of the fibers in the friction and supporting zones to differ.

The simplest embodiment to produce is obtained if the same material composition or the same material is selected for the supporting and friction zones. The friction zone (friction layer) is again understood to be the outer area of the disc at the bottom or top surface, from the surface to the full depth of the channels (to the channel bottom).

The indentations, recesses and channels in the friction layer are transferred to the preform in the green state by suitable dies during pressing. The dies carry negatives of the shapes to be produced, with indentations as elevated portions. The pressed preform contains the above-mentioned fibers or fiber bundles and the carbonizable fractions (pitches and/or resins). This type of material is conventionally known as “CRP”, if carbon fibers are used as the reinforcing fibers.

According to the invention, different mixtures may be fed to the die in succession during filling thereof, in such a way that the finished CRP body is gradually built up and a gradual change in the composition and material characteristics of the finished C/SiC disc may be achieved. In this way, very different material characteristics may be simply established for the supporting and friction zones of the subsequent C/SiC body. As far as a stable material composite and good thermal shock and fluctuating temperature resistance are concerned, a gradual transition of the material characteristics and in particular of thermal expansion is extremely important. Sharp transitions in the material characteristics are avoided with the above-described gradual change in the composition.

In this process stage of preform manufacture, it is, in particular, also possible to use long fibers which are introduced into the composite body in the form of bundles, knitted fabrics, felts, prepregs or mats.

In an advantageous embodiment of the invention, one or several long fiber laid fabrics, prepregs or mats are introduced in the plane of the supporting disc to be formed. It is possible for these to be optionally separated from one another by the press mix. In this way, specific reinforcement of the supporting disc may be effected in the plane in which the centrifugal forces act under application conditions. The supporting disc may be reinforced in this way with long fibers, preferably in the radial direction.

When long fibers are inserted in the radial direction, the length thereof is limited only by the geometric dimensions of the friction disc, when otherwise oriented length is limited by the secant length. It is also possible to place long fibers symmetrically about the center of the disc, in the form of wavy lines, ellipses or circles.

During the pressing process, the mixture containing a pyrolyzable binder (resins and/or pitches) is formed into a CRP which, according to the invention, is already shaped to a near end shape. Curing of the binder is started in the pressing process and may be completed during or after the pressing process. The finished CRP body is then pyrolyzed (to form a porous CRP body) and may be easily finished (for example by grinding) prior to silicification.

The shapes of the channels, recesses and/or indentations in the friction zone resulting from the pressing process are such that the heat transfer surface is increased considerably, as is the air speed past and in the friction zone. The channels preferably have radial or tangential main axes. However, it is also possible to apply secant-shaped, circular or spiral channels. The individual channel elements are preferably connected together in these latter embodiments. The channels are open at least in part towards the center and/or the periphery of the friction disc.

With regard to the depth of the recesses, it should be ensured that air circulation is not introduced too far into the supporting disc. Therefore, the depth of the channels, recesses and/or indentations conventionally amounts to 19% of the disc thickness or less, preferably at most 18%, and particularly preferably at most a sixth of the disc thickness. The depth may also vary within a geometrically associated recess. Good characteristics are achieved if the depth of the channels (and thus the thickness of the friction layer) amounts to at most one eighth of the disc thickness.

The width of the channels, recesses and/or indentations is conventionally 0.2 to 10 times, preferably 0.5 to 5 times and particularly preferably 1 to 2 times the depth thereof.

With the objects of the invention in view, there is also provided a process for producing the friction disc, which comprises filling a die with mixtures of reinforcing fibers and ceramic compositions. The compositions of the mixtures are varied in such a way that the mixture for the annular zone B has a volume fraction of from 0 to 80% of reinforcing fibers and the supporting disc A has a volume fraction of reinforcing fibers being at least 1.01 times of the volume fraction for the annular zone B. The compositions are formed by pressing into an approximately desired shape of the friction disc, firing the shaped body and then converting the shaped body at least in part into silicon carbide by infiltration with liquid silicon and reaction of the silicon with the material of the matrix.

Other features which are considered as characteristic for the invention are set forth in the appended claims.

Although the invention is illustrated and described herein as embodied in a friction disc, a process for the production thereof and a vehicle brake, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic plan view of an annular friction disc with involutely curved channels;

FIG. 2 is a perspective view of an annular friction disc with radial and circular concentric channels;

FIG. 3 is a perspective view of an annular friction disc with a spiral channel; and

FIG. 4 is a perspective view of an annular friction disc with a plurality of involutely shaped curved channels, wherein a layer which contains channel-shaped recesses is covered with an additional top layer, in a right-hand half of the figure.

### DESCRIPTION OF THE PREFERRED EMBODIMENTS

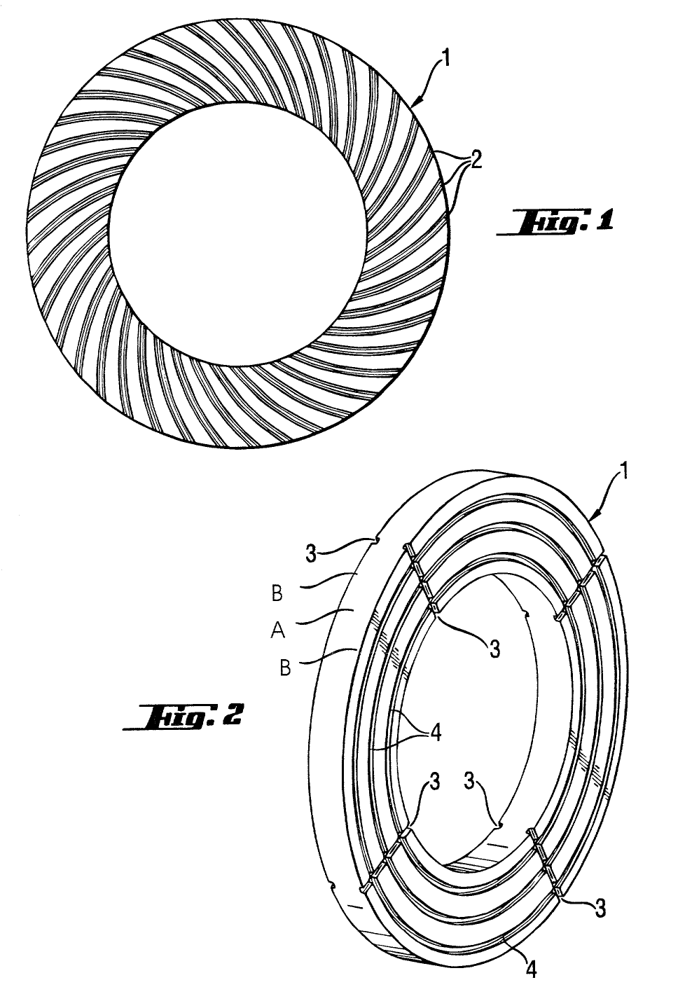

Referring now to the figures of the drawings in detail and first, particularly, to FIG. 1 thereof, there is seen an embodiment of an annular friction disc 1 having a cylindrical zone A to be force-lockingly connected to a shaft. The cylindrical zone A is formed as a supporting disc having a top surface. At least one cylindrical annular zone B formed as a friction layer is connected with the top surface of the supporting disc. The annular zone B has a side remote from the supporting disc with recesses formed therein. In the annular friction disc 1 shown in FIG. 1, the recesses are involutely curved channels 2 provided with an equal width throughout. A higher peripheral speed at an outer edge of the annular friction disc 1 in comparison to a peripheral speed at an inner edge of the ring or annular friction disc effects a pressure gradient during rotation of the disc, causing air to be pumped from the center to the periphery. This air flow effects cooling of a layer in which the channels are formed. In the case of the curvature shown in this figure, the direction of rotation of the wheel is preferably clockwise.

Another channel geometry is shown in FIG. 2, in which radially disposed channels 3 are combined with channels 4 extending concentrically relative to the periphery of the circular ring disc 1.

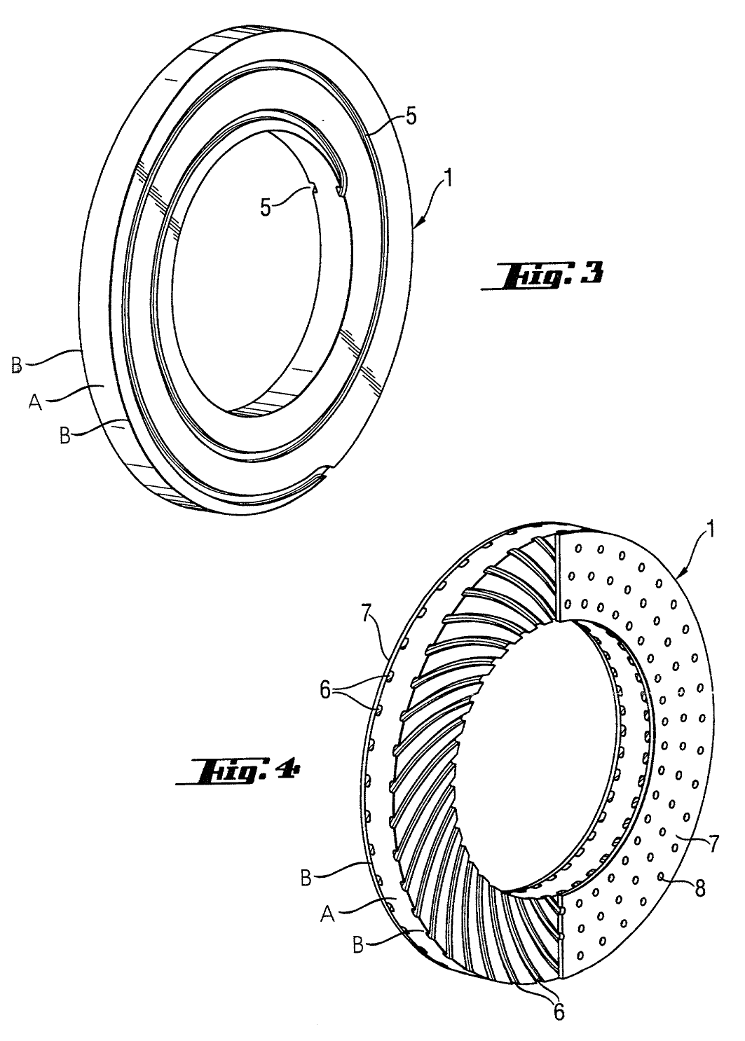

FIG. 3 shows a single spiral channel 5 in the annular friction disc 1. A single spiral channel is shown purely for reasons of clarity, though it goes without saying that a plurality of spiral channels may also be formed in the friction layer. It is also possible to vary the number of turns between openings at the inner and outer peripheries.

The left-hand half of FIG. 4 shows a perspective representation of the annular friction disc 1, which corresponds to the plan view of FIG. 1. In this case, involutely curved channels 6 are again formed in the friction layer. The right-hand half of the figure shows another embodiment, in which an additional top layer 7 is adherently applied over the layer with the channel-shaped recesses, which in this case are likewise involutely curved. The top layer 7 may have holes 8 formed therein (as shown in the figure), which are disposed without exception in such a way that they end in a channel at ends thereof directed towards the friction disc.

According to the embodiment of the invention shown in the right-hand half of FIG. 4, channels, recesses and indentations formed in the annular zone B are not open but rather are partly or completely closed. The depth of the recesses is limited, as above, and the thickness of the top layer amounts to at most 100% of the depth of the recesses. In this embodiment, the friction zone or friction layer (which is in contact with the friction or brake linings) is not the annular zone B but rather the top plate covering them.

According to the invention, the closed channels, recesses and indentations are produced in such a way that a CRP or CFC plate is adhered or joined (top plate) to a CRP shaped body produced by a pressing process (or the CFC shaped body produced by carbonization therefrom), having channels, recesses and indentations. The top plate advantageously is formed of a mixture corresponding to the composition of the friction layer. Since the annular zone B is also in contact with air in this embodiment and therefore is exposed to oxidative damage, the material therefore should be selected as above. Where the adhesion method is used, care should be taken to ensure that all preliminary bodies for the supporting and friction zones and the top plate are simultaneously in either the CRP or the CFC state. The adhesive for joining the friction zone to the supporting disc may include mixtures of a composition related to the friction or supporting zone, which may additionally contain solvents and further organic pyrolyzable binders. The top plate is force-lockingly or frictionally connected to the body of the friction disc after the carbonization and silicification stage.

In a further embodiment of the invention (as illustrated in the right-hand half of FIG. 4), the top plate may contain openings (holes), in such a way that open connections may be obtained to the channels therebelow. The air circulation and cooling effect inside the channels is thereby increased relative to a solid friction zone. Likewise, the wet response behavior of the brake disc may be increased. In order to produce the openings, drilling may be performed after adhesion of the top plates, or top plates provided with prepunched openings may be used during assembly.

This embodiment also allows maintenance or repair of used or superficially damaged discs by grinding off or otherwise removing the worn or damaged top layer and connecting a new top plate. It is possible for the new top plate to be applied by adhesion or advantageously in the form of a CFC preliminary body, which is connected to the friction disc during the silicification stage.

The transition from the friction zone (annular zone B) to the supporting disc A may be defined by a discontinuity in fiber length, fiber content or matrix composition. Such a discontinuity arises, for example in the case of the process variant involving adhesion, due to the adhesive layer. In the case of a gradual material composition transition, or if the supporting and friction zones do not differ with regard to material composition, the friction zone should be understood to mean the surface region as far as the full depth of the recesses, indentations and bores.

In a further embodiment according to the invention, which is not shown herein, individual or several or all of the mutually opposing channels on the friction surfaces are connected together by bores through the supporting disc. In this way, the number and size of the bores or passages are limited by the necessary mechanical strength of the supporting disc.

The (annular disc-shaped) supporting disc A is conventionally constructed in such a way that its outer radius is equal to that of the friction zone (annular zone B or top plate) or greater than that of the friction zone. The outer radius of the supporting disc is preferably 50%, and particularly preferably 80%, greater than the outer radius of the friction zone. The inner radius of the supporting disc may be smaller than that of the friction zone, which may be advantageous in attachment to a bell, that serves in assembly on the shaft.

The friction discs according to the invention are particularly suitable as brake discs, where they withstand high braking energy without damage. They may also advantageously be used, for example, as clutch discs, in particular when high torques are transmitted.

We claim:

1. A friction disc, comprising:
a periphery and a center;
a cylindrical zone A to be force-lockingly connected to a shaft, said cylindrical zone A formed as a supporting disc having a top surface;
at least one cylindrical annular zone B formed as a friction layer and connected with said top surface of said supporting disc;
said annular zone B having a side remote from said supporting disc with recesses formed therein, said recesses having at least one shape selected from the group consisting of radially trapezoidal, involutely curved, elliptical, circular and polygonal, said recesses being at least one of open and closed towards at least one of said periphery and said center;
said supporting disc A formed of a fiber-reinforced ceramic material having a matrix material and said supporting disc A being shaped from a single piece in a green state prior to ceramization;
said annular zone B formed of a ceramic material; and
said ceramic material of said annular zone B and said matrix material of said fiber-reinforced ceramic of said supporting disc A being selected independently of one another from the group consisting of silicon, silicon carbide, silicon nitride, carbon, boron nitride, boron carbide, Si/B/N/C and mixtures thereof.

2. The friction disc according to claim 1, wherein said ceramic material of said annular zone B is fiber-reinforced.

3. The friction disc according to claim 1, wherein said annular zone B has a thickness being at most 19% of a thickness of the friction disc.

4. The friction disc according to claim 1, wherein said annular zone B and said matrix of said supporting disc A are formed of the same material.

5. The friction disc according to claim 1, wherein said annular zone B and said supporting disc A are formed of the same material.

6. The friction disc according to claim 1, wherein said fiber-reinforced ceramic of said supporting disc A contains at least one type of fibers selected from the group consisting of carbon fibers, graphite fibers, silicon carbide fibers, boron nitride fibers, aluminum oxide fibers, Si/B/N/C and silicon dioxide fibers.

7. The friction disc according to claim 2, wherein said fiber-reinforced ceramic material of said annular zone B contains at least one type of fibers selected from the group consisting of carbon fibers, graphite fibers, silicon carbide fibers, boron nitride fibers, aluminum oxide fibers, Si/B/N/C and silicon dioxide fibers.

8. The friction disc according to claim 1, wherein said recesses in said annular zone B are channels being open at least in part towards one of said center and said periphery.

9. The friction disc according to claim 1, which further comprises a top layer covering said annular zone B.

10. The friction disc according to claim 9, wherein said top layer has recesses or holes formed therein.

11. The friction disc according to claim 7, wherein said top layer has holes formed therein providing access to cavities formed by said recesses in said annular zone B between said top layer and said supporting disc A.

12. The friction disc according to claim 2, which further comprises reinforcing fibers in said material of said supporting disc A and in said material of said annular zone B having a volume fraction of 0 to 80%, said volume fraction of said reinforcing fibers in said material of said supporting disc A being at least 1.01 times said volume fraction of said reinforcing fibers in said annular zone B.

13. The friction disc according to claim 2, wherein said supporting disc A and said annular zone B have fiber bundles with a fiber bundle thickness, and said fiber bundle thickness in said supporting disc A is at least 1% greater than said fiber bundle thickness in said annular zone B.

14. A process for producing a friction disc according to claim 1, which comprises:
filling a die with mixtures of reinforcing fibers and ceramic compositions;
varying the compositions of the mixtures in such a way that the mixture for the annular zone B has a volume fraction of from 0 to 80% of reinforcing fibers and the supporting disc A has a volume fraction of reinforcing fibers being at least 1.01 times of the volume fraction for the annular zone B; and
forming the compositions by pressing into an approximately desired shape of the friction disc, firing the shaped body and then converting the shaped body at least in part into silicon carbide by infiltration with liquid silicon and reaction of the silicon with the material of the matrix.

15. A vehicle brake, comprising a friction disc including:
a periphery and a center;
a cylindrical zone A to be force-lockingly connected to a shaft, said cylindrical zone A formed as a supporting disc having a top surface;
at least one cylindrical annular zone B formed as a friction layer and connected with said top surface of said supporting disc;
said annular zone B having a side remote from said supporting disc with recesses formed therein, said recesses having at least one shape selected from the group consisting of radially trapezoidal, involutely curved, elliptical, circular and polygonal, said recesses being at least one of open and closed towards at least one of said periphery and said center;
said supporting disc A formed of a fiber-reinforced ceramic material having a matrix material and said supporting disc A being shaped from a single piece in a green state prior to ceramization;
said annular zone B formed of a ceramic material; and
said ceramic material of said annular zone B and said matrix material of said fiber-reinforced ceramic of said supporting disc A being selected independently of one another from the group consisting of silicon, silicon carbide, silicon nitride, carbon, boron nitride, boron carbide, Si/B/N/C and mixtures thereof.

16. The vehicle brake according to claim 15, wherein said ceramic material of said annular zone B is fiber-reinforced.
